(19) United States
(12) Patent Application Publication
(10) Pub. No.: US 2009/0089385 A1
(43) Pub. Date: Apr. 2, 2009

(54) User initiated and controlled electromagnetic transmissions for remotely rendering a tangible delivarable to recipients

(76) Inventor: Lee Du, Palo Alto, CA (US)

Correspondence Address: Bo-In Lin, 13445 Mandoli Drive, Los Altos Hills, CA, 94022, US

(21) Appl. No.: 12/077,105

(22) Filed: Mar. 17, 2008

Related U.S. Application Data
(60) Provisional application No. 60/997,252, filed on Oct. 1, 2007.

(51) Int. Cl. G06F 15/16

(52) U.S. Cl. 709/206

(57) ABSTRACT

The present invention discloses a network communication system that includes a network processing center for receiving and converting an electro-magnetically transmissible data/content into a physically deliverable object for physically delivering to a recipient.

This application is a Formal Application and claims priority to pending U.S. patent application 60/997,252 filed on Oct. 1, 2007 by the same Applicant of this Application, the benefit of its filing date being hereby claimed under Title 35 of the United States Code.

### BACKGROUND OF THE INVENTION

1. Field of the Invention

This invention relates generally to the systems and methods for applying the network communications to enhance delivery of the electromagnetic-transmissible contents from a sender to the designated recipients. More particularly, this invention is related to methods and network systems that allows a sender to control and direct, and allows a sender to specify among the many options, the delivery of an article that embodies the Internet deliverable contents to designated receivers to achieve delivery speed while reducing the delivery costs.

2. Description of the Related Art

Even through more communications are now carried over the Internet with speed and greatly improved efficiency, however, there are still limitations that the Internet communications cannot satisfy. A most obvious limitation is a communication to a person who has limited or even no access to Internet. This group of people may include some elderly folks or economically disadvantageous people who do not use a computer or devices to have the Internet access at all. As senders of information often initiate a message that is suitable for Internet transmission, e.g., e-mail, the senders are required to apply a different mode of communication, e.g., sending the message as printed copy separately through regular mail services, in order to send the same message to a person who does not communicate over the Internet.

Furthermore, in the field of commercial advertisement, there are still large amount of printed materials delivered through the regular mail services for promoting commercial products or services. However, such distribution of the printed materials for product or service promotion are limited in certain geographic locations, generally within the territory of a nation through the domestic mail services due to a cost considerations. International delivery of printed materials would be too costly for mass mail promotions. Notwithstanding the availability of high-speed data transmission across the globe without national boundaries, an effective solution to overcome the geographic limitations of mail deliveries is still not yet available.

Further limitation of current electronic commerce over the Internet is the lack of control and flexibility of choices for a message or content sender. It is true that a sender of gift or message is provided with options to order gift items from online shops for delivering to a receiver; however, the online shops under most circumstances dictate what and how the messages, and that the messages related with this order, are delivered to the message or gift receiver. A sender does not have much freedom to customize the fashion and ways the messages are delivered.

Another difficulty of the network communications over the Internet is related to the requirements that either a document must be personally delivered or that a returning document must be personally signed before a notary public in order to have a certain legal validity. Particularly, when such document must be delivered to an area that require extended delivery processes and time, such as FedEx or DHL Services, etc (FedEx and DHL are registered trademarks). Even some of these delivery systems may include signatures of the senders and/or recipients but the speed of the Internet transmission has not yet been utilized to provide a solution to overcome such difficulties. Current document systems are further limited by speed when technical or trade journal, magazines, or newspapers are delivered over the national boundaries of remote areas.

Therefore, a need exists in the art of network communications to provide improved system configuration to implement a delivery method for delivering communication items that embody the medium contents according to information and data transferred over the telecommunication network such that the above-discussed difficulties and limitations may be resolved.

### SUMMARY OF THE PRESENT INVENTION

It is therefore an aspect of the present invention to provide new and improved systems and methods to facilitate more rapid and efficient delivery of a tangible deliverable embodiment that contains information transmitted in electromagnetic form via Internet or other equivalent signal transmission systems.

Specifically, it is an aspect of the present invention to provide systems and methods with server stations function as service processing center. The server stations are connected to the Internet or any other types of network systems for transmitting network transmissible contents. The server stations receive and convert the network transmissible contents into physical deliverable items to execute a delivery program as instructed and designated by a message sender to the designated recipient.

Another aspect of this invention is to provide convenience and efficiency setting up processing center with server stations connected through telecommunication network to a message sender. Each of these server stations serves an equivalent function as a modem sender-controllable telegram machine. A message sender transmits network transmittable contents to the server stations. The server stations then download the contents transmitted over the network and convert the content into tangible deliverable items such as a letter, a printed document, a compact disk, or any other physical embodiment of the messages according to a message sender's instruction. The server stations then execute a deliver process to physically deliver the item to a recipient. A sender is enabled to send a letter, a compact disk, or other physically deliverable items containing messages transmittable through Internet without requiring the processes of printing, i.e., without requiring the process by the senders to print the text or convert the contents into a tangible deliverable form, such as a letters or the letters, stuffing the letter or other contents into an envelop, putting a right amount of postage, dropping the mail into a postbox or go to the post office. A sender is provided with an online service to fully control and manage these processes with improved speed and convenience to accomplish actual delivery of the items to any distant locations aided by the global instantaneous message transmissions over the telecommunication network.

Another aspect of this invention is to provide great deal of flexibilities for the sender to specify and customize the packaging and forms of the deliverable items. The deliverable items may be a printed letter or text, an audio or video compact disk (CD) or digital versatile disc (DVD), or in different kinds of physical magnetic or optical medium containing the contents as designated by the sender or any Internet transmissible contents in its present and future technological devices or methods or from or any future developed new technologies. One specific application of these flexibilities is to apply the system and method for mass mailing for commercial advertisement to different locations without being limited by national or other geographical or physical boundaries that typically restrict the speed and often cause higher costs of delivery. The server stations connected through telecommunication network and distributed in different locations can accomplish high-speed timely delivery without encountering distance or national boundary restrictions as that often encountered in conventional mail delivery systems. And the delivery can be specified by the sender for a designated time and date for one-time delivery or planned multiple deliveries.

Another aspect of this invention is the convenience of providing a delivery status-tracing feature to continuously monitoring and confirming the delivery status through the server station serving the function of service processing center distributed over different locations. Such monitoring and confirmation features are particularly useful for timely and securely delivering legal or time sensitive materials.

Briefly, in a preferred embodiment, the present invention discloses a network system includes a server station(s) for receiving a multimedia message through the telecommunication network system. The server station(s) further serve the function of service processing center(s) for converting the multimedia message to a physically deliverable item for physically delivering to a designate recipient(s). In an exemplary embodiment, the server station is a mobile server station installed in a vehicle for driving to designate locations to serve the function of the service-processing center.

In summary, this invention discloses a method for delivering a physically deliverable object to a remote recipient. The method includes steps of transmitting an electro-magnetically transmittable content through a network to a networked processing center for converting the electro-magnetically transmittable content into the physically deliverable object for delivering to the remote recipient.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a network system includes an online server for receiving a sender initiated message and orders to complete a delivery of an article embody contents based on an Internet deliverable content sent by the sender.

FIG. 2 is a flowchart for showing the steps performed by the method of delivering a physically deliverable object to a recipient that embodies electro-magnetically transmittable contents transmitted over the telecommunication network.

### DETAILED DESCRIPTION OF THE PREFERRED EMBODIMENT

Reference is now made to the above listed figures for describing, in detail, the preferred embodiments of the present invention. The figures referred to and the accompanying descriptions are provided only as examples of the invention and are not intended in anyway to limit the scope of the claims appended to the detailed description of the embodiment.

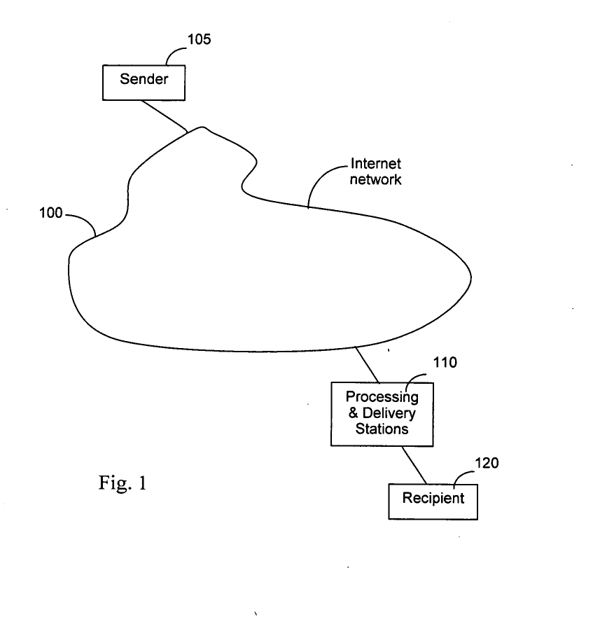

FIG. 1 is a functional block diagram of data communication-network system 100, e.g., an Internet system or a wireless data transmission network. The network includes an online sender 105 connected to the network communication system 100 with a personal computer (PC), or other network data-handling system, through an Internet service provider (ISP) (not shown). The ISP receives a request from the sender 105 through a network interface device. The ISP checks the user ID and password and upon checking out the ID and password, ISP allows the PC to log on to the ISP server for connecting to the network system 100.

The network system further includes an online processing and delivery service station 110, preferably operating an online web-server to receive a message and data from the sender 105. The online processing and delivery service station 110 may include a server to receive and process different files, media contents, or instructions sent by the sender 105. The online processing and delivery service station 110 then processes the files, media contents and instructions as sent by the sender 105 through the Internet 100. According to the instructions and messages received from the sender 105, the online processing and delivery service station 110 then converts the media contents such as video, audio, or other multimedia data transferred by the sender through the Internet 100. The online processing and delivery service station 110 carries out the conversion processes to convert the electronically transferable messages or medium contents into tangible deliverable items and then sends the tangible deliverable item to a recipient 120 as designated by the sender 105. In an exemplary embodiment, the online processing and delivery server stations 110 may be installed on a vehicle to dynamically provide the service at different locations.

In another exemplary embodiment, the electronic audio/video game/computer game can also be uploaded to the service station and transmitted through Internet, then delivered in the designated form (magnetic/optical, or others) to the specified recipient(s). Alternate embodiments may include a function to allow a sender of message or information to make a telephone call. The service station may either capture the audio input of the caller and covert that into printed text or generating an audio file for transmitting the audio file on the Internet for converting into an audio CD or a media that embodies the audio file for delivery to a recipient as designated by the message sender. In summary, the physical object delivery system of this invention allows for every forms of delivering or uploading data or messages to a service station connected either by telephone, telecommunication network including Internet, or through mail or other kinds of communication processes. The data or message are then converted into electromagnetic forms for network transmission and then converted into physical object for delivery.

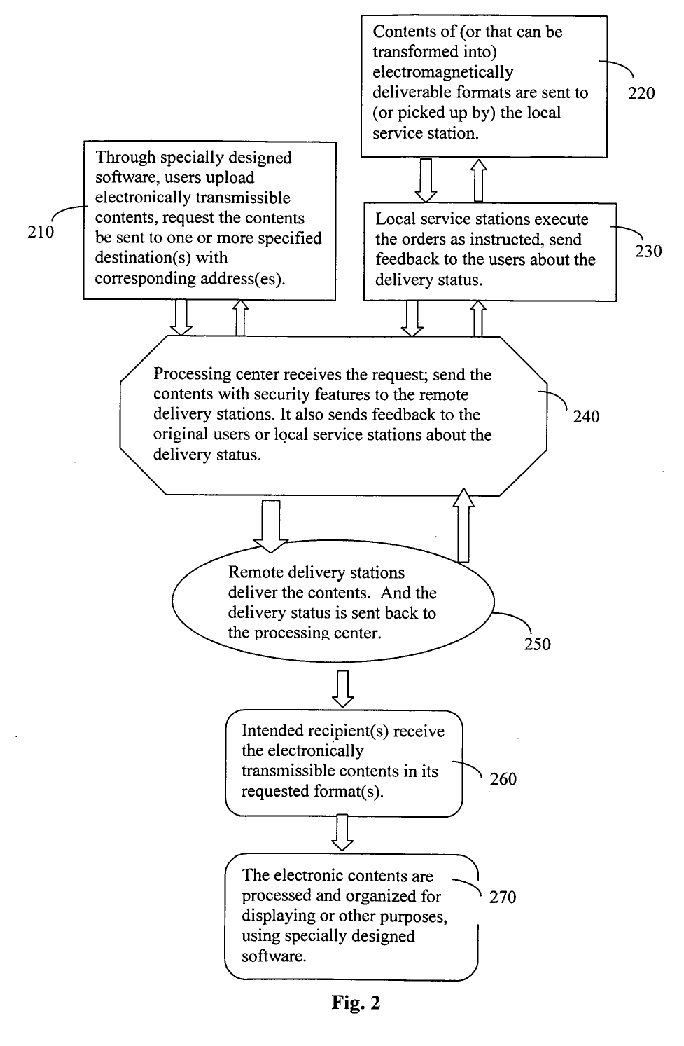

FIG. 2 is a flowchart for illustrating the processes according to an exemplary method of this invention. A user 105 of a telecommunication network for sending a physically deliverable object to a recipient can start the process by either upload electronically transmissible contents to a processing center (step 210). In this case, the processing center may be an online delivery service station 110. Alternately, a user 105 may physically deliver a medium embodies the contents such as a letter or pictures, or other network or electro-magnetically transmissible contents to a local service station (Step 220), or drop the contents in pick-up locations/boxes arranged by the service station. The local service station then executes the orders received from the user and sends a status report to the user to update the user about the delivery status (Step 230). The electromagnetic transmissible contents either uploaded or physically received by the processing center are sent to a remote delivery station through an Internet or other electro-magnetic delivery methods (Step 240). In this step, the processing center further sends a status report about the reception and processing and delivery status of the contents received. Then the remote delivery stations deliver converts the contents received into a physically-deliverable items such as a printed letter, an advertisement post cards, a photo album, a musical or video CD/ DVD or its equivalent, or any deliverable object that embodies the magnetic media, optical media, and other types of medium as may be developed in the future. The physically delivery items are then delivered to the recipients followed by a delivery status report sent back to the user (Step 250). The designated recipient receives the network or electro-magnetically transmissible contents embodied in physical deliverable item. The delivery and the physically deliverable item can be flexibly arranged according to the instructions provided by the user when sending the contents through the network upload or physically delivered the contents to a local service station or when the contents are physically delivered to a local service station (Step 260).

According to above descriptions, this invention discloses a network communication system. The network communication system includes a network processing station for receiving and converting an electro-magnetically transmissible data/content into a physically deliverable object for physically delivering to a recipient. In an exemplary embodiment, the network processing station further receiving and converting a data/content transmitted with an electronic mail (e-mail) into a printed copy for physically delivering to a recipient. In another exemplary embodiment, the network processing station further receiving and converting a data/content transmitted with an electronic mail (e-mail) into a compact disk (CD)/DVD, or other magnetic/optical media for physically delivering to a recipient. In another exemplary embodiment, the network processing station further receiving and converting a data/content transmitted with an electronic mail (e-mail) into a photographic picture for physically delivering to a recipient. In another exemplary embodiment, the network processing station further receiving and converting a data/content downloaded from a website or any other kinds of data-storage or downloadable resources into a printed copy for physically delivering to a recipient. In another exemplary embodiment, the network processing station further receiving and converting a data/content downloaded from a website into a compact disk (CD), or other magnetic/optical media for physically delivering to a recipient. In another exemplary embodiment, the network processing station further receiving and converting a data/content downloaded from a website into a photographic picture for physically delivering to a recipient. In another exemplary embodiment, the network processing station further includes a server for connecting to the network communication system for receiving and converting the electro-magnetically transmissible data. In another exemplary embodiment, the network communication system further includes a local service station for receiving an object from a local sender for converting contents embodied in the object into an electro-magnetically transmissible data for transmitting to the network-processing center. In another exemplary embodiment, the network-processing center further receives instructions about how to convert the electro-magnetically transmissible data into the physically deliverable object and how to physically deliver to the recipient. In another exemplary embodiment, the network communication system further includes a commercial company providing instruction to the network-processing center to deliver the physically deliverable object to many recipients promoting advertising messages represented by the electromagnetic transmissible data. In another exemplary embodiment, the network communication system further includes a local service station for picking up an object as ordered by a local sender for converting contents embodied in the object into the electro-magnetically transmissible data for transmitting to the network processing center.

This invention further discloses a method for delivering a physically deliverable object to a remote recipient. The method includes a step of transmitting an electro-magnetically transmittable content through a network to a networked processing center for converting the electro-magnetically transmittable content into the physically deliverable object for delivering to the remote recipient. In an exemplary embodiment, the step of transmitting and converting the electro-magnetically transmittable content further comprising a step of transmitting a data/content with an electronic mail (e-mail) and converting the data/content into a printed copy for delivering to the remote recipient. In another exemplary embodiment, the step of transmitting and converting the electro-magnetically transmittable content further comprising a step of transmitting a data/content with an electronic mail (e-mail) and converting the data/content into a compact disk (CD) or other magnetic/optical media for delivering to the remote recipient. In another exemplary embodiment, the step of transmitting and converting the electro-magnetically transmittable content further comprising a step of transmitting a data/content with an electronic mail (e-mail) and converting the data/content into a photographic picture for delivering to the remote recipient. In another exemplary embodiment, the step of transmitting and converting the electro-magnetically transmittable content further comprising a step of downloading a data/content from a website and converting the data file into a printed copy for delivering to the remote recipient. In another exemplary embodiment, the step of transmitting and converting the electro-magnetically transmittable content further comprising a step of downloading a data/content from a website and converting the data file into a compact disk (CD) or other magnetic/optical media for delivering to the remote recipient. In another exemplary embodiment, the step of transmitting and converting the electro-magnetically transmittable content further comprising a step of downloading a data/content from a website and converting the data file into a photographic picture for delivering to the remote recipient. In another exemplary embodiment, the method further includes a step of receiving an object by a local service station from a sender for converting contents embodied in the object into the electro-magnetically transmissible data for transmitting to the network-processing center. In another exemplary embodiment, the network processing center receiving and executing instructions from a sender about how to convert the electro-magnetically transmissible data into the physically deliverable object and how to physically deliver to the recipient. In another exemplary embodiment, the method further includes a step of an advertisement company providing instruction to the network-processing center to deliver the physically deliverable object to many recipients for promoting messages represented by the electromagnetic transmissible data. In another exemplary embodiment, the step of transmitting and converting the electro-magnetically transmittable content further comprising a step of transmitting a data/content with an electronic mail (e-mail) and converting the data/content into a commercial or technical journals/magazines, newspapers, for delivering to the remote recipients. In another exemplary embodiment, the step of transmitting and converting the electro-magnetically transmittable content further comprising a step of transmitting a data/content of television contents/movies for distributing to subscribers designated by the sender. In another exemplary embodiment, the step of transmitting and converting the electro-magnetically transmittable content further comprising a step of transmitting a data/content from a mobile phone, a personal digital assistant (PDA), or any other input/output or data handling/processing device that can be accessed through the Internet directly or indirectly. In another exemplary embodiment, the step of transmitting and converting the electro-magnetically transmittable content further comprising a step of transmitting a data/content through a new content-delivery technologies developed before year 2030.

Therefore, this invention provides a system and method to benefit those who may not have convenient Internet access or telecommunication networks for sending and receiving electromagnetic transmittable contents. People of old age or children as well as the less fortunate people who do not have Internet access can be benefited from this invention to receive object transmitted as digital data and delivered as physical deliverable object. This invention further enable the delivery of electronic medium such as CD, USB storage drives or devices, or other electronically recognizable device to replace large amount of paper mails thus saving natural resources deliverable through conventional paper mails. The electronically recognizable devices such as USB storage drives or devices, CD can be recycled repeatedly thus achieving savings of natural resources and benefit the environment. In contrast to messages on printed paper media, the electromagnetic storage devices delivered as physically deliverable objects can contain multimedia video/audio contents much richer, more entertaining and interesting than conventional paper mails. The full spectrum of Internet transmittal digital contents or transmissible through all types of telecommunication network can be implemented according to the embodiments of this invention. The multimedia content transmitted over the telecommunication networks can be further processed with instructions to include gift/greeting cards with customized images, forms, messages and special multimedia features as may be selected and designed by the senders.

Additionally, the deliverable items may embody the software packages or electronic audio/video games that can be uploaded through the telecommunication networks. The remote processing center can download these software programs or electronic audio/video games and covert them as physically deliverable items in CD, or other data storage device for delivering to designated recipients. The same process can be applied to an electronic book such as an electronic audio book. A user may copy a website or the content of a website and send them to the remote process and deliver center for delivering to a designated recipient(s). This feature is useful for those who have Internet access but has limited time to search the Internet. Furthermore, the email for deliverance by the remote process and deliver center with a server should also include the attachments with the e-mail and also including forwarded e-mails with the attachments. The forwarded e-mail can be forward not only once but also many times and to multiple recipients. The content sent to the server in a process and deliver center can also include anything that a business or individual is able to send in the conventional sense including a simple note, or anything else to the customers. For example, the shipment arrives at a business distribution center, a note sent to the customer to pick up the shipment with the customer signing in picking up the items can be also realized in a system of this invention. A customer with Internet access such as an Internet accessible cell phone can directly call the service station and the (or the combination of) audio or video or text messages will be delivered as instructed. Those without the Internet access can also call the service station and the recorded message can be converted into a file and delivered to the designate recipient(s) as physically deliverable items. Of course these deliverable items-may include multimedia contents such as video, audio, texts, etc. The deliverable items can be formatted and arranged such that the multimedia contents may be viewed and listened through the use of various devices such as television device, mobile phone, CD/DVD player, e-book reader, or other devices or equipment that can process or accept electromagnetic transmittable contents/media. The telecommunication network systems for digitally deliver the contents may include wired and wireless systems that may also include Wi-Fi, VoIP (voice over IP) and any other future systems that would be made available for delivery of electronic data.

The telecommunication networks may also include signal transmission through satellite data transmissions too. In this system, instead of uploading the digital contents, the sender may also drop the magnetic or optic disk or data storage devices to a deliver/process center for initiating the process. In a very ‘urgent’ situation, the sender can call the recipient who can go to the local service office or designated agent(s) to pick up the tangible deliverable item. In another configuration of this system, the contents stored in an on-line storage can also be sent through this system by receiving an instruction either through this service (if authorized by the related business) or through a sender for delivering the data stored in the on-line storage to a designate recipient as a physically deliverable item. The delivery of the digital contents over the network communication embodies the whole scopes embodied the current telecommunication network, and the scopes that will possibly be embodied by the telecommunication network in the future according to further advancement of the technologies that may occur through the entire period when the patents issued from the present inventions are valid and in force.

In order to assure security of Internet transmission (or transmission over alternate communication networks), the contents are encrypted to maintain the highest degree of privacy and security. The sender is allowed to have a choice of encryption key or keys or the encryption keys can be generate by a server. The encryption keys are sent separately to a recipient such that the privacy and security of content transmissions can be assured.

With the overload of information, the server and the processing center of this invention further provides a service of archiving, organizing, indexing, content-searching, categorizing and storing the contents delivered such that the contents are easily searchable and retrievable. Software tools are developed and available for providing such services in the processing centers of this invention for the convenience of the users. These software tools can also be made available to be installed and used at the recipient's location.

The service stations may also be implemented as a mobile processing and delivery service station installed on a vehicle. The vehicles with the service equipments required for carrying out the processing and delivery services can be sent to the message sender or designated recipient. Thus, the service can be done near the customer in a timely fashion.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A network communication system comprising:
a network processing station installed on a vehicle for receiving and converting an electro-magnetically transmissible data/content into a physically deliverable object for physically delivering to a recipient.

2. The network communication system of claim 1 wherein:
said network processing station further receiving and converting a data/content transmitted with an electronic mail (e-mail) into a printed copy for physically delivering to a recipient.

3. The network communication system of claim 1 wherein:
said network processing station further receiving and converting a data/content transmitted with an electronic mail (e-mail) into a compact disk (CD)/DVD, or other magnetic/optical media for physically delivering to a recipient.

4. The network communication system of claim 1 wherein:
said network processing station further receiving and converting a data/content transmitted with an electronic mail (e-mail) into a photographic picture for physically delivering to a recipient.

5. The network communication system of claim 1 wherein:
said network processing station further receiving and converting a data/content downloaded from a website or any other kinds of data-storage or downloadable resources into a printed copy for physically delivering to a recipient.

6. The network communication system of claim 1 wherein:
said network processing station further receiving and converting a data/content downloaded from a website into a compact disk (CD), or other magnetic/optical media for physically delivering to a recipient.

7. The network communication system of claim 1 wherein:
said network processing station further receiving and converting a data/content downloaded from a website into a photographic picture for physically delivering to a recipient.

8. The network communication system of claim 1 wherein:
said network processing station further includes a server for connecting to said network communication system for receiving and converting said electro-magnetically transmissible data.

9. The network communication system of claim 1 further comprising:
a local service station for receiving an object from a local sender for converting contents embodied in said object into said electro-magnetically transmissible data for transmitting to said network processing center.

10. The network communication system of claim 1 wherein:
said network processing center further receives instructions about how to convert said electro-magnetically transmissible data into said physically deliverable object and how to physically deliver to said recipient.

11. The network communication system of claim 1 further comprising:
an advertisement company providing instruction to said network processing center to deliver said physically deliverable object to many recipients promoting messages represented by said electromagnetic transmissible data.

12. The network communication system of claim 1 further comprising:
a local service station for picking up an object as ordered by a local sender for converting contents embodied in said object into said electro-magnetically transmissible data for transmitting to said network processing center.

13. A method for delivering a physically deliverable object to a remote recipient comprising:
transmitting an electro-magnetically transmittable content through a network to a networked processing center for converting said electromagnetically transmittable content into said physically deliverable object for delivering to said remote recipient.

14. The method of claim 13 wherein:
said step of transmitting and converting said electro-magnetically transmittable content further comprising a step of transmitting a data/content with an electronic mail (e-mail) and converting said data/content into a compact disk (CD) or other magnetic/optical media for delivering to said remote recipient.

15. The method of claim 13 wherein:
said step of transmitting and converting said electro-magnetically transmittable content further comprising a step of transmitting a data/content with an electronic mail (e-mail) and converting said data/content into a photographic picture for delivering to said remote recipient.

16. The method of claim 13 wherein:
said step of transmitting and converting said electro-magnetically transmittable content further comprising a step of downloading a data/content from a website and converting said data file into a printed copy for delivering to said remote recipient.

17. The method of claim 13 wherein:
said step of transmitting and converting said electro-magnetically transmittable content further comprising a step of downloading a data/content from a website and converting said data file into a compact disk (CD) or other magnetic/optical media for delivering to said remote recipient.

18. The method of claim 13 wherein:
said step of transmitting and converting said electro-magnetically transmittable content further comprising a step of downloading a data/content from a website and converting said data file into a photographic picture for delivering to said remote recipient.

19. The method of claim 13 further comprising:
receiving an object by a local service station from a local sender for converting contents embodied in said object into said electro-magnetically transmissible data for transmitting to said network processing center.

20. A network communication system comprising:
a network processing station for receiving and converting an electro-magnetically transmissible data/content into a physically deliverable object for physically delivering to a recipient.
